(19) United States
(12) Patent Application Publication
(10) Pub. No.: US 2023/0379682 A1
(43) Pub. Date: Nov. 23, 2023

(54) DATA HANDLING FOR A RADIO ACCESS NETWORK CONTROLLER

(71) Applicant: Intel Corporation, Santa Clara, CA (US)

(72) Inventors: Tingjie Chen, Shanghai City (CN); Zhonghua Sun, Shanghai City (CN); Jing Zhao, Beijing (CN); Jing Li, Beijing (CN); Shaohe Feng, Beijing (CN); Yi Sun, Shanghai (CN); Cong Zhang, Shanghai City (CN)

(73) Assignee: Intel Corporation, Santa Clara, CA (US)

(21) Appl. No.: 18/366,808

(22) Filed: Aug. 8, 2023

(30) Foreign Application Priority Data
Jun. 21, 2023 (WO) PCT/CN2023/101922

(51) Int. Cl. H04W 8/00; H04W 72/56

(52) U.S. Cl. CPC H04W 8/00; H04W 72/56; H04W 88/18

(57) ABSTRACT

A network processing device is connected to a host processor device and receives radio access network data on a network describing attributes of the radio access network (RAN). The network processing device further includes a classification engine to determine a priority level for the RAN data and identify a block of memory of the host processor device for the RAN data associated with the priority level. The classification engine generates a cache line in cache of the network processing device to store the RAN data, where the cache line is associated with the block of memory. The network processing device causes the cache line to be flushed to the block of memory with the RAN data based on the priority level.

### CROSS-REFERENCE TO RELATED APPLICATION

This application claims the benefit of priority under 35 U.S.C. § 119(e) to Patent Cooperation Treaty (PCT) International Application No. PCT/CN2023/101922, filed Jun. 21, 2023, which is hereby incorporated by reference in its entirety.

### FIELD

The present disclosure relates in general to the field of distributed computing systems, and more specifically, to data transfers within a computing platform.

### BACKGROUND

Wireless communications systems, both cellular and non-cellular have been evolving over the past several years. With the advent of fifth generation (5G) cellular wireless networks which is considered as the cellular standard to enable emerging vertical applications such as industrial internet of things (IIoT), extended reality (XR), and autonomous systems. These systems impose stringent communication and computational requirements on the infrastructure serving them to deliver seamless, real-time experiences to users. Traditionally, macro base stations provide cellular radio connectivity for devices. This approach suffers from issues such as coverage holes, call drops, jitter, high latency, and video buffering delays.

Connection management is a widely used network solution to achieve optimal load distribution within wireless communication systems based on expected objectives. Traditionally, a user equipment (UE) triggers a handover request based on wireless channel quality measurements. The handover request is then processed by the central unit (CU). This process can be inefficient and slow. Moreover, existing connection management techniques are performed using a UE-centric approach rather than a context-aware, network-level global approach.

### BRIEF DESCRIPTION OF THE DRAWINGS

FIG. 1 is a simplified block diagram illustrating an example network architecture.

FIG. 2 is a simplified block diagram illustrating an example network topology.

FIG. 3 is a simplified block diagram illustrating an example 0-RAN RIC architecture.

FIG. 4 is a simplified block diagram of an example protocol circuitry to implement a Compute Express Link (CXL)-based protocol.

FIG. 5 is a simplified block diagram illustrating an example data center cluster architecture.

FIG. 6 is a simplified block diagram illustrating an example radio access network architecture.

FIG. 7 is a simplified block diagram illustrating an example network processing device.

FIG. 8 is a simplified block diagram illustrating an example system including a network processing device.

FIG. 9 is a simplified block diagram illustrating a data flow within an example system including a network processing device.

FIG. 10 is a simplified flow diagram illustrating an example technique for utilizing a network processing device.

FIG. 11 illustrates a block diagram of an example processor device in accordance with certain embodiments.

Like reference numbers and designations in the various drawings indicate like elements.

### DETAILED DESCRIPTION

Connection management and network management are used by many wireless networks to ensure smooth and well-balanced traffic load across the network. Traditional methods for connection management (e.g., user association) use sub-optimal and greedy mechanisms such as providing a connection of each user to a base station with a maximum receive power.

Cloud computation (as opposed to local, on-device computation) may be used to support the large computational requirements of the emerging vertical applications mentioned previously. However, the communication latency to the cloud service can potentially be very large, resulting in negative user experiences. Multi-access Edge Computing (MEC) addresses this problem by bringing computation resources closer to end users to avoid the typical large delays mentioned above. However, to holistically address the issue, the radio access network (RAN) supporting the connection between user devices and an edge server should be reliable, have high throughput (data rate), and low latency. The network should be enhanced in parallel or jointly with edge computing frameworks to fulfill the requirements for the emerging applications.

In some implementations, connection management may be implemented using machine learning (ML)- and/or artificial intelligence (AI)-based algorithms for performing load-aware connection management and/or handover management to optimize user associations/connections and load balancing to fulfill QoS requirements. For instance, a graph neural network (GNN) model may be used to model or otherwise represent a network, including heterogeneous RANs with multiple types of network elements/nodes such as UEs, central units (CUs), distributed units (DUs), and/or radio units (RUs) and/or multiple RAT types such as one or more WLAN APs, one or more cellular RAN nodes, and the like. These network elements/nodes can interact with one another using standardized and/or predetermined interfaces. Each network element/node in the network is represented as a node in the graph or GNN, and each interface is represented as an edge in the graph/GNN. Representing such a network as a graph allows relevant features to be extracted from network logical entities using GNN tools such as graph convolutional neural network (CNN), spatial-temporal neural network, and/or the like. These tools can learn hidden spatial and temporal features of the network and apply these insights to load balancing and handoff decisions within the network, among other example implementations.

The embodiments discussed herein are also scalable and feasible on various RAN platforms. The connection management may be implemented using a suitable edge computing framework such as the O-RAN network architecture. Additionally or alternatively, connection management algorithms may be executed or defined in logic of an xApp in O-RAN-RIC, 3GPP standards (e.g., SA6Edge), ETSI standards (e.g., MEC), O-RAN standards (e.g., O-RAN), Intel® Smart Edge Open (formerly OpenNESS) standards (e.g., ISEO), IETF standards or RFCs (e.g., MAMS RFC8743), and/or WiFi standards (e.g., IEEE80211, WiMAX, IEEE16090, etc.), among other examples. Additionally or alternatively, the embodiments discussed herein may be implemented as software elements that may be provisioned to any of the aforementioned platforms and/or any other suitable platform as discussed herein.

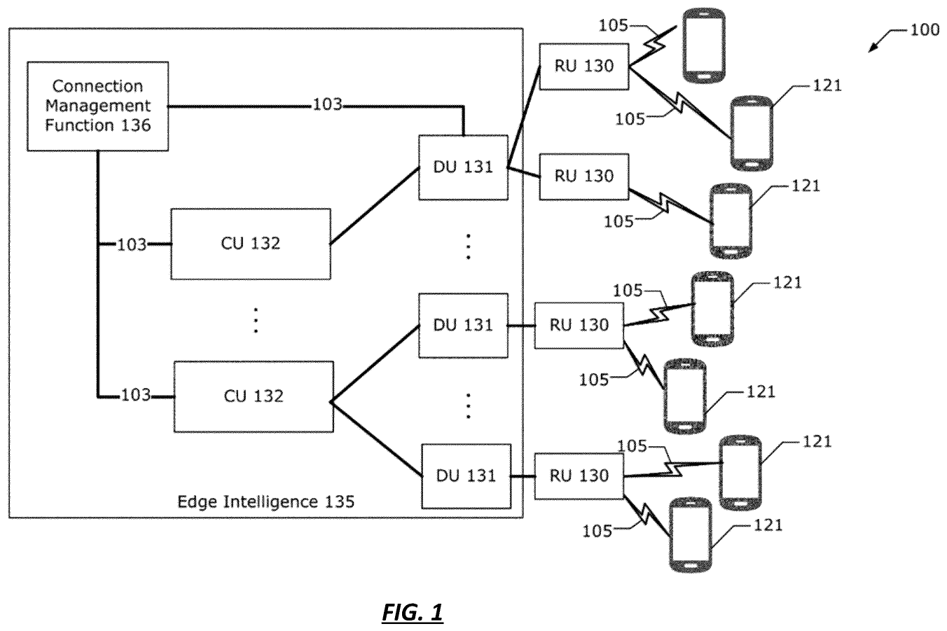

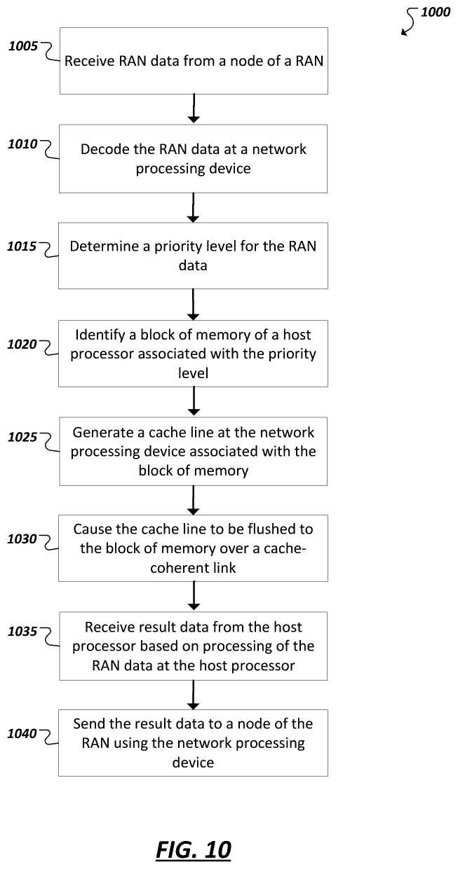

FIG. 1 shows an example network architecture 100 where the protocol stack is split between centralized units (CUs) 132 and distributed units (DUs) 131. The network architecture 100 includes edge intelligence 135. The edge intelligence 135 includes a connection management function (CMF) 136 and a number of CUs 132. The network architecture 100 also includes a number of DUs 131, and number of radio units (RUs) 130. Each DU 131 is communicatively coupled with one CU 132 and one or more UEs 121. The UEs 121 may be the same or similar as the nodes 1020 and/or 1010 discussed infra with respect to FIG. 10. Additionally or alternatively, a DU 131 can be communicatively coupled with the CMF 136. In general, the edge network 100 includes a CMF 136 co-located with one or more CUs 132, DUs 131, RUs 130, and UEs 121. The CUs 132 and some DUs 131 have wired and/or wireless backhaul links 103 to the CMF 136 and supports wireless access 105 to the UEs 121.

In some implementations, the CUs 132 are central controllers that can serve or otherwise connect to multiple DUs 131 and multiple RUs 130. The CUs 132 are network (logical) nodes hosting higher/upper layers of a network protocol functional split. For example, in the 3GPP NG-RAN and/or O-RAN architectures, a CU 132 hosts the radio resource control (RRC), Service Data Adaptation Protocol (SDAP), and Packet Data Convergence Protocol (PDCP) layers of a next generation NodeB (gNB), or hosts the RRC and PDCP protocols when included in or operating as an E-UTRA-NR gNB (en-gNB). The gNB-CU 132 terminates the F1 interface connected with the gNB-DU 131. Additionally or alternatively, each CU 132 may be connected to one or more DUs 131.

Each DU 131 controls radio resources, such as time and frequency bands, locally in real time, and allocates resources to one or more UEs 121. The DUs 131 are network (logical) nodes hosting middle and/or lower layers of the network protocol functional split. For example, in the 3GPP NG-RAN and/or O-RAN architectures, a DU 131 hosts the radio link control (RLC), medium access control (MAC), and high-physical (PHY) layers of the gNB or en-gNB, and its operation is at least partly controlled by gNB-CU 132. One gNB-DU 131 supports one or multiple cells, and one cell is supported by only one gNB-DU 131. A gNB-DU 131 terminates the F1 interface connected with a gNB-CU 132. Additionally or alternatively, each DU 131 may be connected to one or more RUs 130.

The RUs 130 are transmission/reception points (TRPs) or remote radio heads (RRHs) that handle radiofrequency (RF) processing functions. The RUs 130 are network (logical) nodes hosting lower layers based on a lower layer functional split. For example, in the 3GPP NG-RAN and/or O-RAN architectures, an RU 130 hosts the low-PHY layer (e.g., fast Fourier transform (FFT), inverse FFT (iFFT), physical random access channel (PRACH) extraction, etc.). Each of the CUs 132, DUs 131, and RUs 130 are connected through respective links, which may be any suitable wireless, wired (e.g., fiber, copper, etc.) links.

In some implementations, the network architecture 100 (or edge intelligence 135) is implemented using the MEC framework). In these implementations, the CMF 136 is implemented in a MEC host/server, part of a MEC platform, or is a MEC app operated by a MEC host or MEC platform. In other implementations, the CMF 136 can be, or are operated by a Multi-Access Management Services (MAMS) server or a MAMS client. In these implementations, an edge compute node and/or one or more cloud computing nodes/clusters may be the MAMS server, and the CMF 136 is implemented as a Network Connection Manager (NCM) for downstream/DL traffic or a Client Connection Manager (CCM) for upstream/UL traffic. An NCM is a functional entity that handles MAMS control messages from clients (e.g., UEs 121), configures the distribution of data packets over available access paths 105 and (core) network paths 103, and manages user-plane treatment (e.g., tunneling, encryption, etc.) of the traffic flows). The CCM is the peer functional element in a client (e.g., UEs 121) that handles MAMS control-plane procedures, exchanges MAMS signaling messages with the NCM, and configures the network paths 105/103 at the client for the transport of user data (e.g., network packets, etc.). In still other implementations, the CMF 136 can be part of a 3GPP edge computing architecture. In these implementations, the CMF 136 is implemented as an Edge Application Server (EAS), Edge Enabler Server (EES), and/or Edge Configuration Server (ECS) in an Edge Data Network (EDN). These implementations and architectures may be augmented, in some instances, using an improved network processing devices, such as an infrastructure processing unit (IPU), smart network interface controller (NIC), or other device, with the network processing device possessing logic to assist in connection management and offload tasks from a host or other system implementing other portions of the controller management (e.g., the CMF). A CXL link may be used to couple the network processing device to the host, such as discussed in more detail below.

As an additional example, the CMF 136 can be part of the O-RAN framework. In these implementations, the CMF 136 can be part of a RAN Intelligent Controller (RIC) such as a Non-Real Time (RT) RIC or a Near-RT RIC. Additionally or alternatively, the CMF 136 can be implemented using one or more applications, microservices, or software tools (e.g., xApp) operated by a RIC. In some implementations, a RIC may leverage AI/ML techniques to perform connection management. Additionally or alternatively, in O-RAN implementations, the CUs 132 are O-RAN CUs (also referred to as “O-CUs 132”), the DUs 131 are O-RAN DUs (also referred to as “O-DUs 131”), and the RUs 130 are O-RAN RUs (also referred to as “O-RUs 130”). In O-RAN implementations, network management may be hierarchical with a mix of central and distributed controllers located at a CU 132, DUs 131, and/or RUs 130, respectively. In other implementations, the CMF 136 can be part of a cellular network such as a 3GPP 5th Generation (5G) core network (5GC). In these implementations, the CMF 136 can be part of an existing network function (NF) or application function (AF) residing in, or connected to other NFs in the core network. Alternatively, the CMF 136 can be implemented as a new NF within the core network, among other examples.

In addition or alternatively to the various examples mentioned previously, the CMF 136 techniques and technologies can be applied to other types of networks of different communicating nodes. In some examples, a network can comprise a set of autonomous or semi-autonomous nodes (e.g., autonomous driving vehicles (AVs), robots, drones, unmanned aerial vehicles (UAVs), Internet of Things (IoT) devices, autonomous sensors, etc.) where the (semi-) autonomous nodes organize the communications amongst themselves. In these examples, one of the autonomous nodes, a gateway device, network appliance, or other like element may be utilized to takes the role of (or operates) the CMF 136. In these examples, the connections or links between the autonomous nodes may be cellular links (e.g., 5G/NR, LTE, WiMAX, and/or any others discussed herein), WLAN links (e.g., WiFi, and/or any others discussed herein), vehicle-to-everything (V2X) links/connections (e.g., cellular V2X, ITS-G5, DSRC, etc.), short-range and/or wireless personal area network (WPAN) technologies (e.g., Bluetooth/BLE, ZigBee, WiFi-direct, and/or any others discussed herein), and/or any other suitable access technology. In another example, a network can comprise a set of servers, hardware accelerators, and switch fabric in one or more data centers or other like facility that may be spread across one or more geographic locations. In these examples, a switch fabric, one or more of the servers (or a virtual machine operated by a server), or other like element takes the role of (or operates) the CMF 136. In these examples, the connections or links can be a suitable switch or interconnect technology. Additionally or alternatively, the connection management techniques and technologies can also be applied to other types of networks and/or RATs such as, for example, where the CU 132, DUs 131, and/or RUs 130 are WiMAX base stations, WiFi access points, gateway devices, network appliances (e.g., switches, routers, hubs, firewalls, etc.), application servers, data aggregators, and/or the like.

When a UE 121 tries to connect to a network (or network access node (NAN)), a network entity has the functionality to provide initial access by connecting the UE 121 to a cell. Similarly, when a UE 121 moves it needs to keep its connection to the network for smooth operation, which is facilitated by connection management. In addition to managing initial access and mobility, connection management solutions can also be programmed to achieve optimal load distribution. Traditionally, a UE 121 triggers a handover (HO) request based on wireless channel signal/quality measurements. The HO request is then processed by the CU 132. Connection management solutions may be traditionally performed using a UE-centric approach rather than a context-aware, network-level global approach. A common UE-centric technique involves using a received signal reference power (RSRP) based cell-UE association. When a UE 121 moves away from a serving cell, the RSRP from the serving cell will degrade with time while its RSRP with a target cell will increase as it gets closer to it. Therefore, a simple UE-centric maximum RSRP selection approach involves switching to a new cell when the measured RSRP from a target cell is stronger than a threshold or stronger than the measured RSRP of the current serving cell. While this “greedy” approach is simple and effective, it does not take into consideration the local and global network status and lacks adequate load balancing, among other example shortcomings. Other implementations may leverage machine learning or artificial intelligence techniques to attempt to assist with and optimize UE handover, such a predicting obstacles to associating UEs 121 to new cells. Other algorithms may implement load-aware connection management which considers the structure of wireless networks (e.g., as modeled within a neural network (NN) model (e.g., a graph neural network (GNN)), among other example techniques.

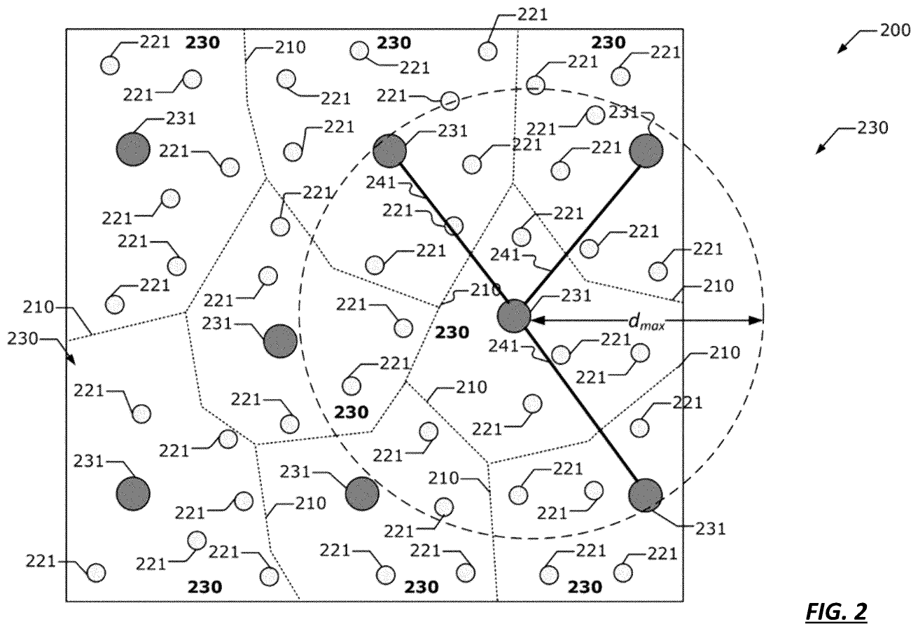

FIG. 2 shows a representation of an example network deployment (or network) 200. The network 200 may include multiple cells 230, where each cell 230 has a cell boundary 210 around a network access node (NAN) 231 that serves or otherwise provides the cell 230. The UEs 221 within a cell boundary 210 are provided network connectivity by the corresponding NAN 231. In other examples, one or more NANs 231 can serve or otherwise provide multiple cells 230 such as, for example, in carrier aggregation (CA) and/or dual connectivity (DC) implementations. Individual NANs 231 correspond to one or more DUs and/or one or more RUs. In this example, the network 200 includes a number of NANs 231 or cells (the terms “NAN”, “RU”, “DU”, and “cell” may be used interchangeably throughout the present disclosure, although these terms refer to different concepts) and a number of UEs 221 (e.g., with the NANs 231/cells and UEs 221 collectively referred to as “network equipment”, “network nodes”, “communication equipment”, “communication nodes”, or the like).

As mentioned previously, the CMF 136 can be implemented using the O-RAN framework (see e.g., O-RAN), where the CMF 136 can be implemented as an xApp operated by a RIC. In O-RAN, xApps are applications designed to run on the near-RT RIC to provide one or more microservices. The microservices obtain input data through interfaces between the RIC and RAN functionality, and provide additional functionality as output data to a RAN. In various embodiments, an example CMF may be implemented as one or more xApps that provides connection management for network deployments. For instance, components or functionality of a RIC (e.g., xApps) may be used for “connection events” (sometimes referred to as “measurement events” or “mobility events”) in which mobile users in a network request new connections, which may include, for example, connection establishment, connection re-establishment, connection reconfiguration, connection release (e.g., to re-direct the UE 221) to a different frequency or carrier frequency), connection suspension, connection resumption, handovers, cell selection or cell re-selection, measurement report triggering, radio link failure/recovery, WiFi associate messages, WiFi reassociate messages, WiFi disassociate messages, WiFi measurement requests and/or measurement reports, WiFi channel switch, and/or other mobility and state transitions. In one example, a UE 221 performs signal/cell measurements continuously or in response to some configured trigger condition and reports the measurements to the RAN/RAN node when certain conditions are met. For signal/cell measurements, the network can configure one or more types of measurements (e.g., RSRP, RSRQ, SINR, RSCP, EcNO, etc.) as trigger quantity. The collection of measurements at a UE 221 and/or receipt of a measurement report from a UE 221 may be considered to be a “measurement event” or “connection event”. When the CMF 136 detects a connection event (e.g., receipt of a measurement report, an HO request for an intra-RAT HO and/or inter-RAT HO, cell selection message, cell reselection message, radio link failure detection and recovery message(s), beam failure detection and recovery message(s), WiFi associate messages, WiFi reassociate messages, WiFi disassociate messages, WiFi measurement requests and/or measurement reports, WiFi channel switch, and the like), the CMF 136 may utilize a connection management algorithm (e.g., a GNN-RL model or other ML model) to make new connection decisions to optimize the network 100 such as by balancing the load across the network 100.

In one example, a NAN 231 may send a measurement configuration to a UE 221 to request a measurement report from the UE 221 when certain configured event(s) are triggered, and the UE 221 performs signal quality and/or cell power measurements for channels/links of one or more cells 230 and/or one or more beams. The UE 221 may perform measurements for cell selection and cell reselection, as well as for HO operations. When a UE 221 is camped on a cell provided by a NAN 231, the UE 221 may regularly or periodically search for a better cell or beam according to cell or beam (re)selection criteria. For cell (re)selection, if a better cell is found, that cell or beam may be selected, and the UE 221 may tune to that cell's 230 control channel(s). For beam (re)selection, if a better beam is found, the UE 221 may tune to the beam's anchor channel(s). Using the new beam or cell, the UE 221 can receive system information, registration area information (e.g., tracking area information (TAI)), other access stratum (AS) and/or non-AS (NAS) information, and/or paging and notification messages (if registered), as well as transfer to connected mode (if registered). Additionally or alternatively, based on the measurement results, some configured events may trigger the UE 221 to send a measurement report to the serving (source) NAN 231 (e.g., when a signal strength or quality of a neighboring cell or beam is stronger than a signal strength or quality of a serving cell or beam). The serving (source) NAN 231 may decide to handover the UE 221 to a target NAN 231 by initiating an HO operation. To initiate the HO operation, the source NAN 231 transmits an HO request message to the target NAN 231, and in response, the source NAN 231 receives an HO request acknowledgement (ACK) from the target NAN 231. Once the HO request ACK is received, the source NAN 231 sends an HO command to the UE 221 to begin an attachment process with the target NAN 231.

For purposes of the present disclosure, a measurement report and/or a request for new cell connection is/are referred to as a “conn-event.” Conn-events are provided or otherwise indicated to the CMF 136 by one or more CUs 132. When the CMF 136 receives a conn-event, the CMF may makes new connection decisions for one or more UEs 221 to balance the load across the network (or a portion of a network). It is expected that an O-RAN RIC deployments will include hundreds of cells (e.g., 230) and thousands of UEs (e.g., 221).

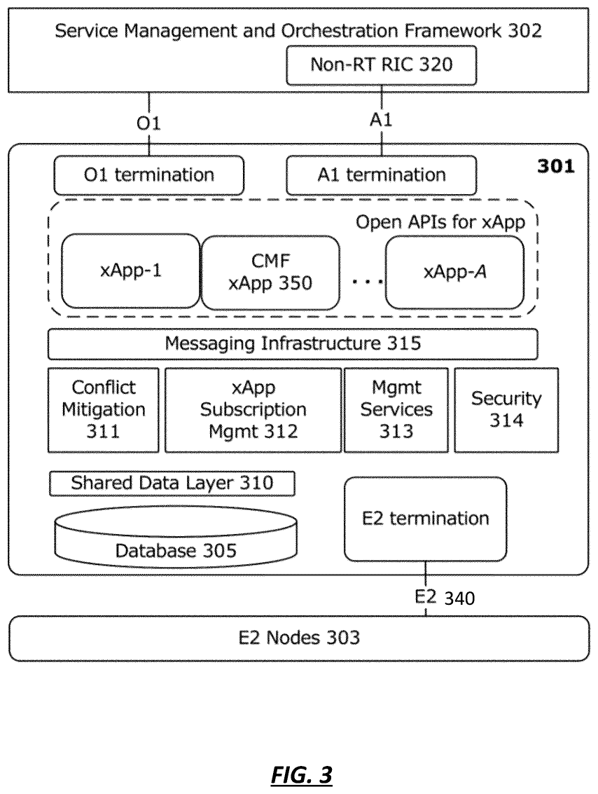

FIG. 3 is a simplified block diagram 300 depicting an example of O-RAN Near-RT RIC architecture 300. The RIC 302 may operate one or more multiple xApps, or other applications or software-based tools configured to run on the Near-RT RIC 302 to implement intelligence or logic of the RIC and implement functionality of the RIC 302. For instance, xApps may include several microservices, which obtain input data through interfaces between the Near-RT RIC 302 and RAN functionality, and provide additional functionally as outputs to the RAN (e.g., including one or more NANs 231, CUs 132, DUs 131, and/or RUs 130). Here, the logical functions of the xApp, which optimize CU 132, DU 131, and RU 130 functions and resources, run with near real-time control loops (e.g., of 10 milliseconds (ms) to 1 second(s)). The Near-RT RIC 301 allows for the reading and writing of RAN and/or UE information, messaging infrastructure, and interfaces to service management and orchestration (SMO) 302 and E2 nodes 303. The E2 nodes 303 includes one or more CUs 132 and one or more cells 230 (e.g., DUs 131 and/or RUs 130). Connection management functionality of an example RIC may be implemented as a CMF xApp 350, which utilizes the O1, A1, and E2 interfaces in the Near-RT RIC 301 and may work in conjunction with other xApps of the RIC 302.

The Near-RT RIC 301 may be connected (at the A1 termination) to the Non-RT RIC 320 in the SMO 302 via the A1 interface/reference point. The Non-RT RIC 320 supports intelligent RAN optimization by providing policy-based guidance, ML model management and enrichment information to the Near-RT RIC 301 function so that the RAN can optimize various aspects such as Radio Resource Management (RRM) under certain conditions. The Non-RT RIC 320 can also perform intelligent RRM functionalities in non-real-time intervals (e.g., greater than 1 second). In some implementations, the Non-RT RIC 320 can use data analytics and AI/ML training/inference to determine the RAN optimization actions for which it can leverage SMO 302 services such as data collection and provisioning services of the O-RAN nodes.

The Near-RT RIC 301 is a logical function that enables near real-time control and optimization of E2 nodes 303, functions, and resources via fine-grained data collection and actions over an E2 interface with control loops in the order of 10 ms to 1s. E2 nodes (e.g., 303) may include various devices or components, such as one or more NANs 231, CUs 132, DUs 131, and/or RUs 130. The Near-RT RIC 301 hosts one or more xApps (e.g., 3 ##) that use E2 interface to collect near real-time information (e.g., on a UE 221 basis and/or a cell/NAN 231 basis) and provide value added services. The near real-time information may include one or more measurements/metrics such as those discussed herein. The Near-RT RIC 301 control over the E2 nodes 303 may be steered via the policies and the enrichment data provided via the A1 interface from the Non-RT RIC 320. In embodiments, the Near-RT RIC 301 collects cell/NAN features, link features, and UE features from the E2 nodes via the E2 interface 340. The cell/NAN features may include, for example, aggregate rate of a NAN 231, resource utilization (e.g., used/unused resource blocks (RBs), physical RBs (PRBs), etc.) of the NAN 231, and/or other RAN/NAN metrics/measurements. The link features may include, for example, channel/signal quality measurements such as spectral efficiency (SE), UE measurement report data, and/or other like link-related measurements/metrics. The UE features may include, for example, UE rate (e.g., data rate, bit rate, etc.), UE resource utilization (e.g., resource blocks (RBs), physical RBs (PRBs), etc.), UE state/status (e.g., RRC protocol states or the like), and/or other like UE-related measurements/metrics. The aforementioned features may be collected based on averages and/or other statistical descriptions and the like.

An example Near-RT RIC 301 may host or otherwise provide functionality such as database functionality (e.g., using database 305), which allows reading and writing of RAN/UE information; conflict mitigation 311, which resolves potentially overlapping or conflicting requests from multiple xApps (e.g., the conflict mitigation entity 311 is responsible for resolving conflicts between two or more xApps); xApp Subscription Management (Mgmt) 312, which merges subscriptions from different xApps and provides unified data distribution to xApps; management services 313 including xApp life-cycle management, and fault, configuration, accounting, performance, security (FCAPS) management of the Near-RT RIC 301, as well as logging, tracing, and metrics collection which capture, monitor, and collect the status of Near-RT RIC internals and can be transferred to external system for further evaluation; security 314, which provides the security scheme for the xApps; Management Services including, for example, fault management, configuration management, and performance management as a service producer to SMO; and messaging infrastructure 315, which enables message interaction amongst Near-RT RIC internal functions. The xApp subscription management 312 manages subscriptions from the xApps to the E2 nodes 303, and enforces authorization of policies controlling xApp access to messages. Additionally or alternatively, the xApp subscription management 312 enables merging of identical subscriptions from different xApps into a single subscription to the E2 Node 303, among other examples.

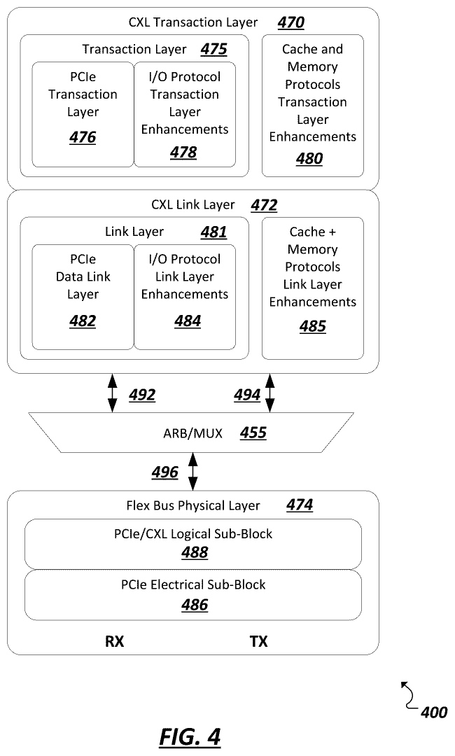

Traditional RICs may also hosts or otherwise provide interface termination including E2 termination, which terminates the E2 interface from an E2 Node 303; A1 termination, which terminates the A1 interface from the Non-RT RIC 320; and O1 termination, which terminates the O1 interface from the SMO 302. The Near-RT RIC 301 also hosts or otherwise provides various functions hosted by xApps, which allow services to be executed at the Near-RT RIC 301 and the outcomes sent to the E2 Nodes 303 via E2 interface. In various embodiments, the xApp functionality hosted by the Near-RT RIC 301 includes the CMF 136 implemented as CMF xApp 400. One or more xApps may provide UE-related information to be stored in a UE-Network Information Base (UE-NIB) (see e.g., UE-NIB 405 of FIG. 4). The UE-NIB 405 maintains a list of UEs 221 and associated data. The UE-NIB 405 maintains tracking and correlation of the UE identities associated with the connected E2 nodes 303. One or more xApps may provide radio access network related information to be stored in a Radio-Network Information Base (R-NIB). The R-NIB stores the configurations and near real-time information relating to connected E2 nodes 303 and the mappings between them. The UE-NIB and the R-NIB may be stored in the database 305. Various aspects of the O-RAN architecture, including aspects of the Non-RT RIC 320 and Near-RT RIC 301, among other examples. In some implementations, such as discussed herein, a RIC (e.g., 301) may be implemented utilizing a host processor device. In some cases, functionality of a traditional RIC may be distributed between the host processor devices, and another device, such as a network processing device (e.g., an IPU), which may manage communications from the E2 nodes 303 and relieve the load placed on the host processor device, by handling some of the messaging infrastructure (e.g., 315), among potentially other features and functionality of the RIC, such as discussed in the examples below. Further, interconnect protocols, such as CXL, may be utilized to facilitate communication and coordination between the network processing device and the host processor device working to implement RIC functionality, among other example features, such as outlined in more detail below.

FIG. 4 is a simplified block diagram 400 illustrating example protocol logic, implemented in hardware and/or software, to implement a Compute Express Link (CXL) protocol. It should be appreciated, that while much of the discussion centers on features provided by a CXL-protocol and communication channels compliant with CXL, that other substitute protocols with similar, comparable features may be substituted for CXL in the embodiments discussed below. The CXL interconnect protocol is designed to provide an improved, high-speed CPU-to-device and CPU-to-memory interconnect designed to accelerate next-generation data center performance, among other applications. CXL maintains memory coherency between the CPU memory space and memory on attached devices, which allows resource sharing for higher performance, reduced software stack complexity, and lower overall system cost, among other example advantages. CXL enables communication between host processors (e.g., CPUs) and a set of workload accelerators (e.g., graphics processing units (GPUs), field programmable gate array (FPGA) devices, tensor and vector processor units, machine learning accelerators, networking accelerators, purpose-built accelerator solutions, among other examples). Indeed, CXL is designed to provide a standard interface for high-speed communications, as accelerators are increasingly used to complement CPUs in support of emerging computing applications such as artificial intelligence, machine learning and other applications.

A CXL link may be a low-latency, high-bandwidth discrete or on-package link that supports dynamic protocol multiplexing of coherency, memory access, and input/output (I/O) protocols. Among other applications, a CXL link may enable an accelerator to access system memory as a caching agent and/or host system memory, among other examples. CXL is a dynamic multi-protocol technology designed to support a vast spectrum of accelerators. CXL provides a rich set of sub-protocols that include I/O semantics similar to PCIe (CXL.io), caching protocol semantics (CXL.cache), and memory access semantics (CXL.mem) over a discrete or on-package link. Based on the particular accelerator usage model, all of the CXL protocols or only a subset of the protocols may be enabled. In some implementations, CXL may be built upon the well-established, widely adopted PCIe infrastructure (e.g., PCIe 5.0), leveraging the PCIe physical and electrical interface to provide advanced protocol in areas include I/O, memory protocol (e.g., allowing a host processor to share memory with an accelerator device), and coherency interface.

FIG. 4 shows an example protocol stack and associated logic (implemented in hardware and/or software) utilized to implement CXL links. For instance, the protocol logic may be organized as multiple layers to implement the multiple protocols supported by the port. For instance, a port may include transaction layer logic (e.g., 470), link layer logic (e.g., 472), and physical layer logic (e.g., 474) (e.g., implemented all or in-part in circuitry). For instance, a transaction (or protocol) layer (e.g., 470) may be subdivided into transaction layer logic 475 that implements a PCIe transaction layer 476 and CXL transaction layer enhancements 478 (for CXL.io) of a base PCIe transaction layer 476, and logic 480 to implement cache (e.g., CXL.cache) and memory (e.g., CXL.mem) protocols for a CXL link. Similarly, link layer logic 472 may be provided to implement a base PCIe data link layer 482 and a CXL link layer (for CXl.io) representing an enhanced version of the PCIe data link layer 484. A CXL link layer 472 may also include cache and memory link layer enhancement logic 485 (e.g., for CXL.cache and CXL.mem).

Continuing with the example of FIG. 4, a CXL link layer logic 472 may interface with CXL arbitration/multiplexing (ARB/MUX) logic 455, which interleaves the traffic from the two logic streams (e.g., PCIe/CXL.io and CXL.cache/CXL.mem), among other example implementations. During link training, the transaction and link layers are configured to operate in either PCIe mode or CXL mode. In some instances, a host CPU may support implementation of either PCIe or CXL mode, while other devices, such as accelerators, may only support CXL mode, among other examples. In some implementations, the port (e.g., a Flex Bus port) may utilize a physical layer 474 based on a PCIe physical layer (e.g., PCIe electrical PHY 486). For instance, a Flex Bus physical layer may be implemented as a converged logical physical layer 488 that can operate in either PCIe mode or CXL mode based on results of alternate mode negotiation during the link training process. In some implementations, the physical layer may support multiple signaling rates (e.g., 8 GT/s, 16 GT/s, 32 GT/s, etc.) and multiple link widths (e.g., x16, x8, x4, x2, x1, etc.). In PCIe mode, links implemented by the port may be fully compliant with native PCIe features (e.g., as defined in the PCIe specification), while in CXL mode, the link supports all features defined for CXL. Accordingly, a Flex Bus port may provide a point-to-point interconnect that can transmit native PCIe protocol data or dynamic multi-protocol CXL data to provide I/O, coherency, and memory protocols, over PCIe electricals, among other examples.

The CXL I/O protocol, CXL.io, provides a non-coherent load/store interface for I/O devices. Transaction types, transaction packet formatting, credit-based flow control, virtual channel management, and transaction ordering rules in CXL.io may follow all or a portion of the PCIe definition. CXL cache coherency protocol, CXL.cache, defines the interactions between the device and host as a number of requests that each have at least one associated response message and sometimes a data transfer. The interface consists of three channels in each direction: Request, Response, and Data.

The CXL memory protocol, CXL.mem, is a transactional interface between the processor and memory and uses the physical and link layers of CXL when communicating across dies. CXL.mem can be used for multiple different memory attach options including when a memory controller is located in the host CPU, when the memory controller is within an accelerator device, or when the memory controller is moved to a memory buffer chip, among other examples. CXL.mem may be applied to transactions involving different memory types (e.g., volatile, persistent, etc.) and configurations (e.g., flat, hierarchical, etc.), among other example features. In some implementations, a coherency engine of the host processor may interface with memory using CXL.mem requests and responses. In this configuration, the CPU coherency engine is regarded as the CXL.mem Master and the Mem device is regarded as the CXL.mem Subordinate. The CXL.mem Master is the agent which is responsible for sourcing CXL.mem requests (e.g., reads, writes, etc.) and a CXL.mem Subordinate is the agent which is responsible for responding to CXL.mem requests (e.g., data, completions, etc.). When the Subordinate is an accelerator, CXL.mem protocol assumes the presence of a device coherency engine (DCOH). This agent is assumed to be responsible for implementing coherency related functions such as snooping of device caches based on CXL.mem commands and update of metadata fields. In implementations, where metadata is supported by device-attached memory, it can be used by the host to implement a coarse snoop filter for CPU sockets, among other example uses.

In some implementations, an interface may be provided to couple circuitry or other logic (e.g., an intellectual property (IP) block or other hardware element) implementing a link layer (e.g., 472) to circuitry or other logic (e.g., an IP block or other hardware element) implementing at least a portion of a physical layer (e.g., 474) of a protocol. For instance, an interface based on a Logical PHY Interface (LPIF) specification to define a common interface between a link layer controller, module, or other logic and a module implementing a logical physical layer (“logical PHY” or “log PHY”) to facilitate interoperability, design and validation re-use between one or more link layers and a physical layer for an interface to a physical interconnect, such as in the example of FIG. 4. Additionally, as in the example of FIG. 4, an interface may be implemented with logic (e.g., 481, 485) to simultaneously implement and support multiple protocols. Further, in such implementations, an arbitration and multiplexer layer (e.g., 455) may be provided between the link layer (e.g., 472) and the physical layer (e.g., 474). In some implementations, each block (e.g., 455, 474, 481, 485) in the multiple protocol implementation may interface with the other block via an independent interface (e.g., 492, 494, 496). In cases where bifurcation is supported, each bifurcated port may likewise have its own independent interface, among other examples.

CXL is a dynamic multi-protocol technology designed to support accelerators and memory devices. CXL provides a rich set of protocols. CXL.io is for discovery and enumeration, error reporting, peer-to-peer (P2P) accesses to CXL memory and host physical address (HPA) lookup. CXL.cache and CXL.mem protocols may be implemented by various accelerator or memory device usage models. An important benefit of CXL is that it provides a low-latency, high-bandwidth path for an accelerator to access the system and for the system to access the memory attached to the CXL device. The CXL 2.0 specification enabled additional usage models, including managed hot-plug, security enhancements, persistent memory support, memory error reporting, and telemetry. The CXL 2.0 specification also enables single-level switching support for fan-out as well as the ability to pool devices across multiple virtual hierarchies, including multi-domain support of memory devices. The CXL 2.0 specification also enables these resources (memory or accelerators) to be off-lined from one domain and on-lined into another domain, thereby allowing the resources to be time-multiplexed across different virtual hierarchies, depending on their resource demand. Additionally, the CXL 3.0 specification doubled the bandwidth while enabling still further usage models beyond those introduced in CXL 2.0. For instance, the CXL 3.0 specification provides for PAM-4 signaling, leveraging the PCIe Base Specification PHY along with its CRC and FEC, to double the bandwidth, with provision for an optional flit arrangement for low latency. Multi-level switching is enabled with the CXL 3.0 specification, supporting up to 4K Ports, to enable CXL to evolve as a fabric extending, including non-tree topologies, to the Rack and Pod level. The CXL 3.0 specification enables devices to perform direct peer-to-peer accesses to host-managed device memory (HDM) using Unordered I/O (UIO) (in addition to memory-mapped I/O (MMIO)) to deliver performance at scale. Snoop Filter support can be implemented in Type 2 and Type 3 devices to enable direct peer-to-peer access using the back-invalidate channels introduced in CXL.mem. Shared memory support across multiple virtual hierarchies is provided for collaborative processing across multiple virtual hierarchies, among other example features.

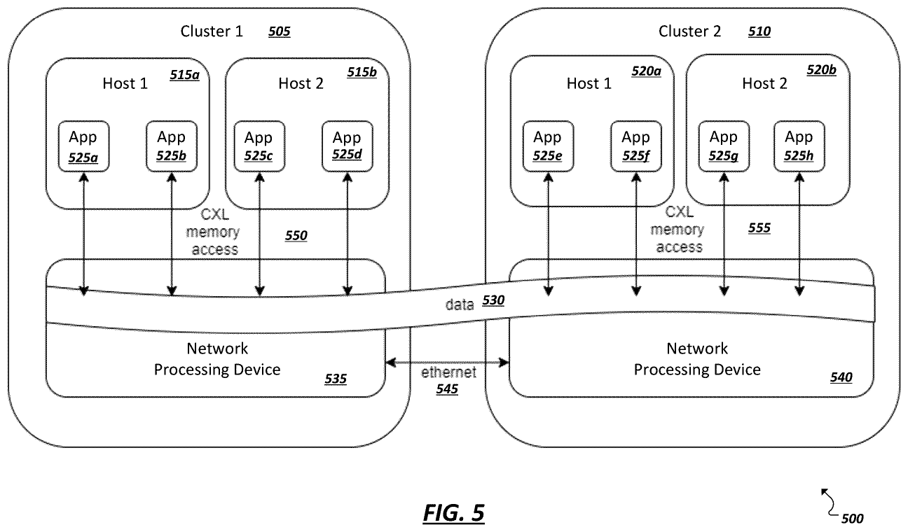

CXL is capable of maintaining memory coherency between the CPU memory space and memory on attached devices, so that any of the CPU cores or any of the other I/O devices configured to support CXL may utilize these attached memories and cache data locally on the same. Further, CXL allows resource sharing for higher performance. Systems, such as systems implementing a RIC, may leverage the combined features of CXL and smart network processing devices (e.g., IPUs), which achieve these efficiencies with minimal movement of networking data and enhanced near memory processing. Such improved clusters can realize smaller latency, better resources utilization, and lower power consumption, among other example benefits. FIG. 5 is a simplified block diagram 500 illustrating a logical view of such a portion of such an improved cluster. As introduced above, a service mesh can be composed of one or multiple clusters (e.g., 505, 510). Host devices (e.g., 515a, 515b, 520a, 520b, etc.) may each host various programs, services, or applications (e.g., 525a-h), which are executed on the corresponding host and which may share and operate various data on the service mesh. All of the data 530 moving within the cluster may be handled using the corresponding cluster's network processing device (e.g., 535, 540), with the network processing device further handling the inter-cluster communications and the internal connections of hosts and the network processing device within the cluster. Attached memory of the network processing device may be utilized to implement a memory pool for the cluster. Accordingly, data used in transactions within the cluster may be saved in the memory pool on the network processing device. Accordingly, when the host device accesses the data within a transaction, the host device can utilize CXL memory accesses (e.g., 550, 555) to directly read or write data through the CXL cached memory as if it were local memory.

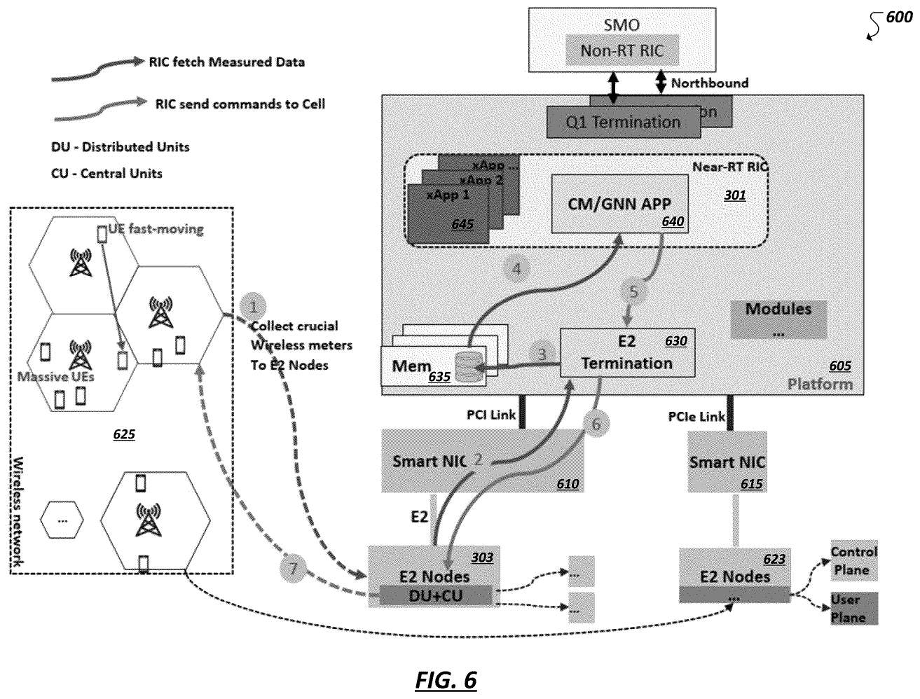

FIG. 6 is a simplified block diagram 600 illustrating an example data flow of a traditional implementation of a Near-RT RIC (e.g., 301) executed and implemented entirely on a host processor platform 605. Network interface controllers (NICs) (e.g., 610, 615) may be utilized to couple the host platform 605 to various E2 nodes 303, 623 (e.g., DU devices, CU devices, etc.). Connection management (CM) is a crucial function in 5G wireless networks. Indeed, in modern cellular networks, connection management may be difficult, such as scenarios where user equipment (US) is fast moving as in in-vehicle computing systems (e.g., self-driving or autonomous driving support systems such as Autopilot), environments with massive numbers of UEs (such as soccer fans in a stadium), and other examples. Connection management in some implementations may be difficult to confirm with “Smooth & Well-balance operation in 5G” based on “UE greedy max RSRP based handover”. In such situations, global management of the connectivity for UEs and cells may be utilized to avoid unbalanced results (e.g., excessive numbers of UEs connecting to a single cell (e.g., missing adjacent cells)).

In one example, a RIC (e.g., 301) may be utilized in an O-RAN deployment to perform global connection management (e.g., using one or more xApps or other software tools executed in or in connection with the RIC). For instance, one or more xApps of the RIC may be configured to perform connection management tasks utilizing various algorithms (e.g., a GNN-based algorithm). E2 interfaces may be utilized to communicate data to the RIC, for instance, with data be received through nodes (e.g., E2 nodes), such as baseband units (BBUs), or distributed units (DUs) and centralized units (CUs) within radio access network 625 (e.g., a 5G cellular network). The E2 nodes may gather radio access network (RAN) data (e.g., according to 3GPP TS28.552) and report the data to E2 termination 630. The E2 termination 630, in this example, may be provided on the host platform 605 itself and may interface, on the platform, with host memory 635 and the near-RT RIC 301, which may execute a number of software tools, including xApps, one of which may include a GNN-based connection management application 640. The E2 termination 630 on the host platform 605, is utilized to receive and transmit (and decode and encode) data on an E2 interface. For instance, RAN data may be received from the RAN 625 via network interface controller (NIC) 610. In some cases, the NIC 610 notifies the host platform 605 of incoming data utilizing interrupt requests (IRQs) and sends the data over an E2 interface to E2 termination logic 630. The E2 termination 630 decodes the data in parallel with the numerous host tasks performed at the platform 605 (e.g., by a host processor (e.g., CPU)) and stores the decoded data in memory 635 of the platform. The RAN data is fetched from memory by the CPU of the platform 605 and fed into local cache (e.g., last level cache (LLC)) to be fetched and utilized by the CM xApps 645, for instance, in an inference-based algorithm, to determine global handover decisions and other aspects of the connection management, and the RIC 301 send related commands to the RAN via the E2 termination 630, NIC 610, and E2 nodes (e.g., 303) to effect the UEs' handover.

Challenging this arrangement, however, are implementations, such as fast fading wireless channel scenarios, where the UEs' received signal measurements (e.g., which may be included in or otherwise affect the RAN data received by and consumed by the RIC 301), such as reference signal received power (RSRP), reference signal received quality (RSRQ), signal interference+noise ratio (SINR), received signal strength indicator (RSSI), and others, vary quickly. xApps may access and utilize different types of RAN data in connection with the tasks performed by the xApps, including connection management, and may access such data in different time slots. The processing resources of the platform processor(s) may thus be tasked with not only decoding large amounts of data (e.g., at the E2 termination), but also executing xApps (e.g., 645) at the RIC 301 in connection with delivering services to the RAN 625. This may challenge the system's, and the platform's 605, ability to provide and process the prerequisite RAN data in a timely and accurate manner at xApps of the RIC 301 to provide the resulting connection management decisions and commands in an effective manner, among other example issues.

In some implementations, providing data to an RIC 301 and performing connection management and other activities for a RAN 625 may be improved by utilizing an enhanced network processing device together with a processing platform. A portion of the logic and associated functionality of a traditional processing platform may be offloaded to the enhanced RIC to enable processing resources of the processing platform to be more fulling dedicated to implementing the RIC and executing xApps. For instance, E2 termination logic may be implemented in the enhanced network processing device, together with logic to classify data for consumption by the RIC and prioritize delivery of the data to the processing platform (and RIC).

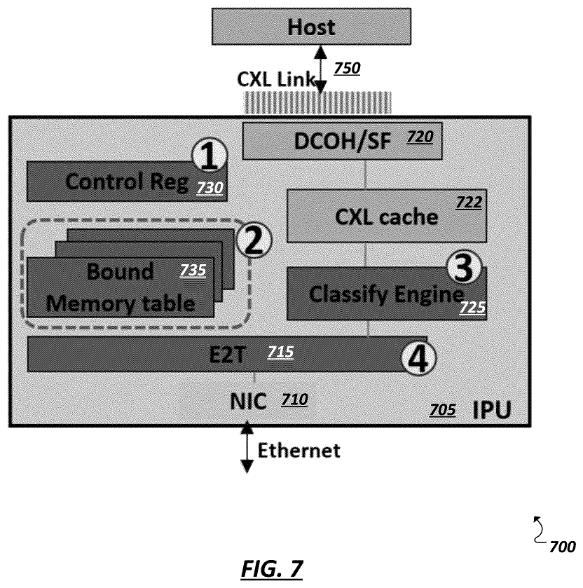

Turning to FIG. 7, a simplified block diagram 700 is shown illustrating an example implementation of a network processing device 705, such as an enhanced smart NIC, infrastructure processing unit (IPU), or another device. The network processing device 705 may include a network port 710 to couple the network processing device 705 to a network (e.g., via an Ethernet link) and in some implementations NIC circuitry to allow the network processing device 705 to implement features of a NIC or replace a NIC in the architecture. The network processing device 705 may additionally include E2 termination circuitry 715 to allow E2 termination logic and E2 interface decoding/encoding to be implemented at the network processing device 705 (e.g., instead of a host processing device). The network processing device 705 may also include a port 720 to implement a multi-protocol, low-latency, high-bandwidth path allowing the network processing device 705 to access memory of a connected host processor device. In some implementations, the port 720 may be compliant with a CXL-based protocol to implement a CXL link to couple the network processing device 705 to a host processor device over which RAN data processed by the network processing device 705 is provided to a RIC hosted on the host processing system, among other examples. In some implementations, port logic 720 may include circuitry to implement cache-coherent transactions, such as through a device coherency agent (DCOH) and snoop filter (SF), as well as a CXL cache 722 for use by the port 720, among other examples.

Continuing with the example of FIG. 7, the network processing device 705 may include a classification engine 725 implemented in hardware circuitry and/or firmware to classify RAN data received and decoded by the E2 termination circuitry 715 from E2 nodes in a network. The E2 termination circuitry 715 may be likewise used to encode and deliver data output from xApps in a RIC to E2 nodes in a network (e.g., over corresponding E2 interfaces based on 5G O-RAN specifications). In this manner, resources of a host processing device coupled to the network processing device 705 may be reserved for other, higher value workloads than managing E2 termination, among other example benefits.

In the example of FIG. 7, the network processing device 705 may be utilized to not only offload E2 termination, but also to process RAN data prior to it being forwarded to the RIC to prioritize, or sequence RAN data based on priority. The manner in which RAN data is to be prioritized by the network processing device 705 may be defined using a set of registers (e.g., 730, 735) resident on the network processing device 705. For instance, one or more control registers 730 (e.g., implemented as control or configuration registers compliant with a CXL- or PCIe-based protocol) may be provided through which the host processing device (and associated xApps that are to run on the RIC hosted on the host processing device) may configure the other registers in the set, such as the bound memory table 735, to direct the manner in which classification engine 725 is to sequence data for delivery to the host processor. The bound memory table 730 may include a number of able entries defining bound memory ranges within the host and assigns priority levels to the specific bound memory ranges. The network processing device 705, using the classification engine 725, may identify received RAN data and determine that the RAN data is to have a particular priority level applied to it. Based on this classification, the network processing device 705 can cause the data to be pushed or flushed to the corresponding bound memory range in the host processing device for consumption by the xApps (e.g., a connection management xApp) running on the host processing device.

Table 1 illustrates an example of a control register 735. The host processing device may write to the control register 730 to direct the networking processing device 705 how to configure the bound memory table 735. In one example, a set of control registers 730 may be provided in standard PCIe/CXL memory mapped configuration space. After the host processing device (e.g., based on one or more xApps, NR-RIC, or other logic executed on the host processing device) sets the control register 730, the network processing device 705 may find corresponding bound memory table 735 entries whose “Table Identity” field matches the “Target Table” field”, with the remaining attributes (e.g., Priority, Address, Memory Size, etc.) set according based on the matched bound memory table entry.

TABLE 1
Example Control Register

| Field | Type | Value | Description |
|---|---|---|---|
| Target | Unsigned | e.g., | Number of the target table entry, |
| table | INT | 0x00000002 | (e.g., an identifier of “2” indicates |
| | | | that attribute values are to be set |
| | | | into a bound memory table entry |
| | | | with a matching Table Identity |
| | | | value) |
| Priority | Unsigned | e.g., | Higher value indicates higher |
| | INT | 0x00000001 | priority when CXL cache is flushed |
| | | | back to bound memory. |
| Address | Unsigned | e.g., Address: | System address of the |
| | Long int | 0x21000000000 | corresponding memory range in |
| | | | the host memory block. |
| Memory | Unsigned | Range size of | Size of one memory block in host |
| Size | Long int | memory: e.g., | system or in CXL memory. |
| | | 64K | |

Table 2 represents an example implementation of a bound memory table 735. A bound memory table may include CXL cache memory attributes, with entries in the table indicating a corresponding block of system memory bound to CXL cache lines. The bound memory table 735 may indicate a “Priority” or priority level to associate with the described block of memory, with priority values being used to flush cache lines according to a preferential order. For instance, higher priority values may indicate that corresponding cache lines (e.g., in CXL cache 722) are to be flushed over the CXL link 750 firstly (e.g., utilizing the CXL.cache protocol) and lower priority values indicating that a corresponding cache line should be flushed after higher priority data has been flushed, among other examples (e.g., where lower priority values in the bound memory table indicate a higher priority level, etc.). The host processor may cause values in a bound memory table (e.g., priority values) to be adjusted dynamically (e.g., through writes to a corresponding control register 730).

TABLE 2
Example Bound Memory Register

| Field | Type | Value | Description |
|---|---|---|---|
| Table | Unsigned | e.g., | Identity of the definite table |
| Identity | Int | 0x00000002 | entry, value 2 indicates a |
| | | | second table provided by this |
| | | | IPU device. |
| Priority | Unsigned | e.g., | High value indicates high priority |
| | Int | 0x00000001 | when CXL cache is flushed back |
| | | | to bound memory in host. |
| Address | Unsigned | e.g., Address: | system address of memory range |
| | Long int | 0x21000000000. | about Memory block; default |
| | | Default: | Oxffffffffffffffff indicates the |
| | | 0xffffffffffffffff. | table is not specified with right |
| | | | value. |
| Memory | Unsigned | Range size of | Size of one memory block in host |
| Size | Long int | memory: | system. |
| | | e.g., 64K | Default value: 0, indicates the |
| | | | table is not set. |

The classification engine 725 may parse and classify data (e.g., RAN data) received and decoded by the E2 termination circuitry to determine a priority level to be associated with the data. For instance, RAN data may be classified based on fields or metadata and a definition provided by or in accordance with one or more xApps of a connected host processing device. Table 3 illustrates example classification definitions, as may be provided or set in accordance with one or more xApps. For instance, SINR measurement data may be identified by the classification engine 725 and classified as priority level “2” data, among other examples. From this classification, the classification engine 725 may consult the bound memory table(s) to identify a block of memory (e.g., an address) that is associated with priority level 2. Accordingly, the classification engine 725 may identify the corresponding target memory range and the data to CXL cache 722 to form corresponding CXL cache lines. The cache line corresponding to the data may be flushed to the host processing device's associated memory based on the priority level to the corresponding memory block (e.g., while leveraging the DOCH/SF logic of the CL port to keep coherency in accordance with the CXL protocol). The xApps and/or RIC on the host processing device may then access the flushed data for consumption (e.g., in connection with connection management operations), among other examples.

TABLE 3
Example Priority Assignments to Different Data Sets

| Data Set | Priority | Data Set Description |
|---|---|---|
| Set-1 | 2 | SS-RSRP distribution per SSB. |
| | | SS-RSRP distribution per SSB of neighbor NR cell. |
| | | SINR measurement. |
| Set-2 | 1 | SS-RSRP distribution per SSB. |
| | | SS-RSRP distribution per SSB of neighbor NR cell. |
| Set-3 | 3 | Mean number of RRC Connections. |
| | | Max number of RRC Connections. |
| | | Min number of RRC Connections. |
| Set-4 | 4 | DL PRB used for data traffic. |
| | | Average DL UE throughput in gNB. |
| | | Total number of DL TBs. |

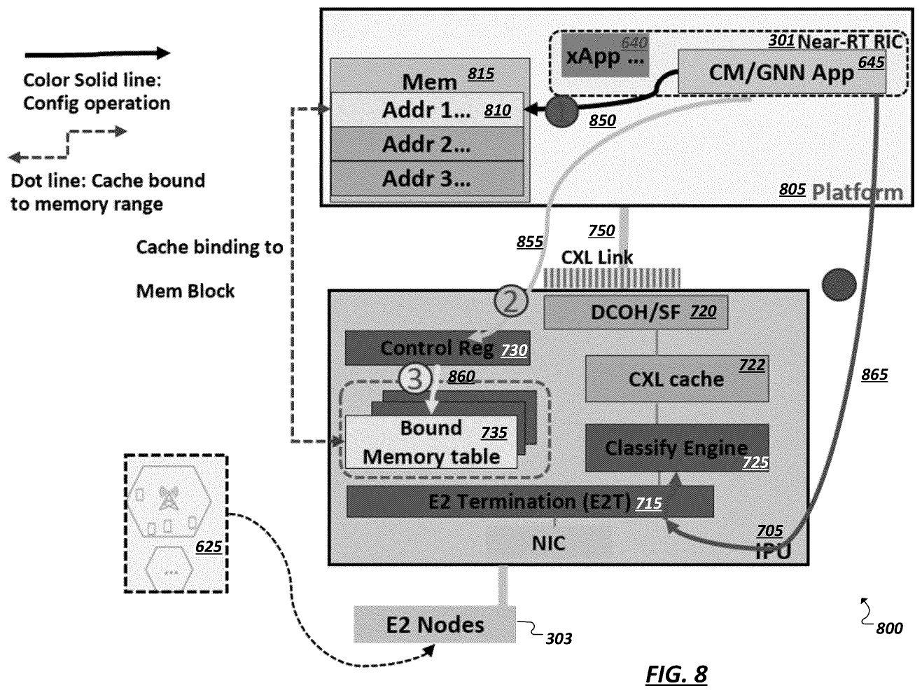

Turning to FIG. 8, a simplified block diagram 800 is shown of an enhanced network processing device 705 is shown, coupled to E2 nodes 303 and an example host processing platform 805 via a CXL link 750. An example flow is shown for configuring the network processing device 705 to properly prioritize and direct (or bind) lines in CXL cache 722 to memory blocks (e.g., 810) in the platform 805 for use by one or more xApps 640 in a Near-RT RIC 301. The host processing platform 805 may prepare 850 memory 815 to designate various blocks (e.g., 810) for use by the RIC 301, for instance, utilizing the memory blocks as a database for storing RAN data to be consumed by a particular application (e.g., a GNN-based connection management xApp 645), which has been pushed, flushed, or otherwise delivered to the host processing platform 805 from the network processing device 705. The xApp (e.g., 640, 645) or an associated driver may be used to communicate and set 855 these memory block assignments within the network processing device, for instance, by writing to control registers 730 and set multiple different priority levels for the passing of data directly from the networking processing device cache (e.g., 722) to the designated memory blocks (e.g., 815) over the link (e.g., CXL link 750). Register management logic of the network processing device 705 may set 860 the bound memory tables 735 based on the information set in the control registers 730. For instance, the “Target Table” attribute may be used to find a bound memory table with a matching “Table Identity” entry value. The register management logic may move attributes from the control register to the corresponding bound memory table, including Priority, Address, Memory Size, and others. In some implementations, a respective bound memory table may be provided for each of the memory blocks designated at the host processing platform for use by xApps or other tools of the RIC. In some implementations, tools (e.g., xApps) of the host processing platform 805 may also designate 865 which data sets or data set characteristics should be considered by the classification engine 725 in determining priority levels to be assigned to incoming RAN data at the network processing unit. In some implementations, priority level-data set mappings may be communicated from xApps to the classification engine 725 via the E2 termination circuitry and an E2 interface, among other examples. For instance, the xApp may utilize particular data sets as prerequisite inputs to making UE handover decisions, and such data sets may be assigned a correspondingly high priority level, among other examples.

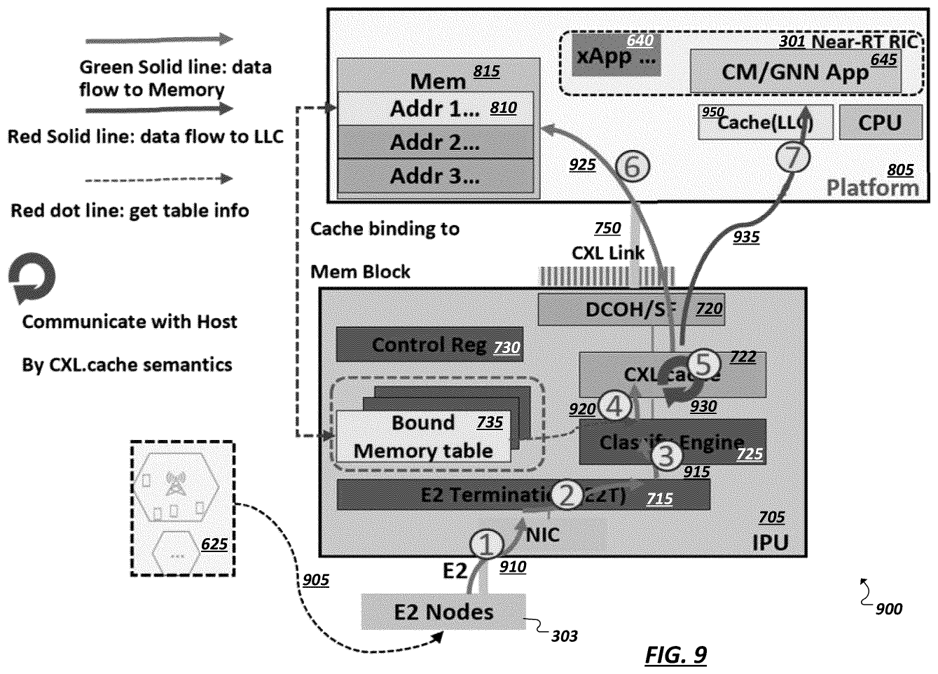

Turning to FIG. 9, once the bound memory tables 735 and classification engine 725 are configured (e.g., using a procedure such as shown in the example of FIG. 8), the network processing device 705 may be utilized to improve the handling of RAN data for consumption by an example xApp. FIG. 9 shows an example flow of particular RAN data being pushed (e.g., flushed or evicted) from an enhanced network processor device 705 to memory 815 of a host processing device 805 for consumption by a RIC 301 (e.g., a Near-RT RIC). RAN data may be received 905 at E2 nodes 303 from a radio network 625 (e.g., a 5G data network). The RAN data may be received 910 at the network processor device 705 over an E2 interface from the E2 nodes 303 and the E2 termination circuitry 715 may decode the data and provide 915 the (sometimes large amounts of) data to the classification engine 725. The classification engine 725 considers the data set-priority level mapping information, mapping, rules, or other information (e.g., provided by xApps (e.g., 640, 645) of the host processing platform 805) to determine respective priority levels for the RAN data decoded by the E2 termination circuitry 715.

Continuing with the example of FIG. 9, the classification engine 725 may be used to populate cache lines in cache 722 based on the determined priority level for a received RAN data set. The classification engine may package the received data in an efficient manner (e.g., stripping the data of fields that will not be used by the consuming xApp). The classification engine 725 may identify and read 920 a bound memory table corresponding to the priority level determined for the data set to determine the system memory block address to associate with the local cache line used to store the data set (e.g., RAN data set). This association serves to direct the flushing (e.g., 925) of the data set to the corresponding system memory block (e.g., 810). Accordingly, the classification engine 725 generates the cache line based on information pulled from the corresponding bound memory table 735 (corresponding to the determined priority level) including Address and Memory Size, etc. In one example, the cache line may be generated 930 based on a CXL-based protocol (e.g., CXL.cache) and may assign an appropriate cache state designation to the cache line (e.g., “Modified” in a CXL Modified-Exclusive-Shared-Invalid (MESI) protocol model). Other cache-coherent protocols may be utilized to perform such flushes or evictions in other implementations with different cache coherency state models.

In some implementations, the network processing device 705 may utilize semantics of a cache coherent interconnect protocol to push, flush, or evict a line of its local cache, in which RAN data is stored (as decoded by E2 termination circuitry 715) to the memory or cache of the host processor device to effectively deliver the RAN data to one or more xApps executing in a RIC on the host processor device. In one example, the protocol circuitry of the port (e.g., 720) may be utilized to send a read request from the network processing device 705 to the host processor device 805 over the link 750, where the read request includes a writeback to memory (e.g., a CXL.cache RdOwn request). In such an instance, the read may allow the network processing device 705 to secure ownership of the memory block (e.g., designated to receive RAN data associated with a particular priority level) and write or evict the RAN data directly to the memory block (e.g., 810) using protocol circuitry of the network processing device and host processor device implementing the link 750 and without the involvement of software. In some implementations, an xApp (e.g., a GNN CM xApp 645) may be actively using local cache 950. The xApp may identify (e.g., from a cache miss) that it is to use incoming RAN data from the network processing device and cause a fetch operation over the link 750 (e.g., in association with a CXL bias flip) to fetch 935 cache lines from the cache 722 of the network processing unit 705 directly to the fast cache 950 used at the host processor device, among other example implementations. Where cache lines of RAN data are available to be evicted or fetched from the network processing unit 705, but the cache lines have been determined (by the classification engine) to have two different priority levels, the classification engine 725, in association with the port protocol logic, may cause the higher priority level cache line to be delivered for use by the RIC 301 on the host processor device 805 before the lower priority level cache line.

Turning to FIG. 10, a simplified flow diagram 1000 is shown illustrating an example technique for utilizing a network processing device, such as an IPU, Smart NIC, Edge Processing Unit (EPU) (e.g., to perform edge orchestration and management tasks), Smart RIC, or DPU, to enhance the passing of data to a RAN controller in a host processing platform. In one example, RAN data may be received 1005 from a RAN (e.g., from a RAN node (e.g., E2 node)) at a first interface of the network processing device. The network processing device may include interface termination circuitry to decode 1010 the data and further parse the decoded data to determine attributes of the RAN data and thereby determine 1015 one of a plurality of different priority levels to apply to the RAN data based on the attributes. A plurality of blocks of memory of the host processor device may be mapped to the plurality of different priority levels (e.g., based on a bound memory table or other register of the network processing device, which may be configured at the direction of the host processor device (e.g., based on an Near-RT RIC or xApp executed on the host processor device). The network processing device may identify 1020 a particular one of the blocks of memory associated with the priority level and generate 1025 a cache line in cache of the network processing device associated with the particular block of memory (e.g., as a copy of the particular block of memory) and store the RAN data in the cache line. The network processing device may cause 1030 the cache line to be evicted or flushed 1030 back to the particular block of memory using a flush, writeback, or other operation defined in a cache-coherent protocol, such as CXL, used on a link coupling the network processing device to the host processor device. The timing of the flushing of the cache line to the host processor device may be based on the priority level associated with the RAN data, cache line, and particular memory block, with high priority levels taking precedence over lower priority levels, allowing higher priority data to be delivered and consumed by the host processor device before lower priority data. The host processor device may generate results data based on the consumption of the delivered RAN data (e.g., using a RIC or xApp) and may pass the results data back (at 1035) to the network processing device to allow the network processing device to forward (at 1040) the result data back to entities of the RAN to perform connection management or other services at the RAN, among other example features and implementations.

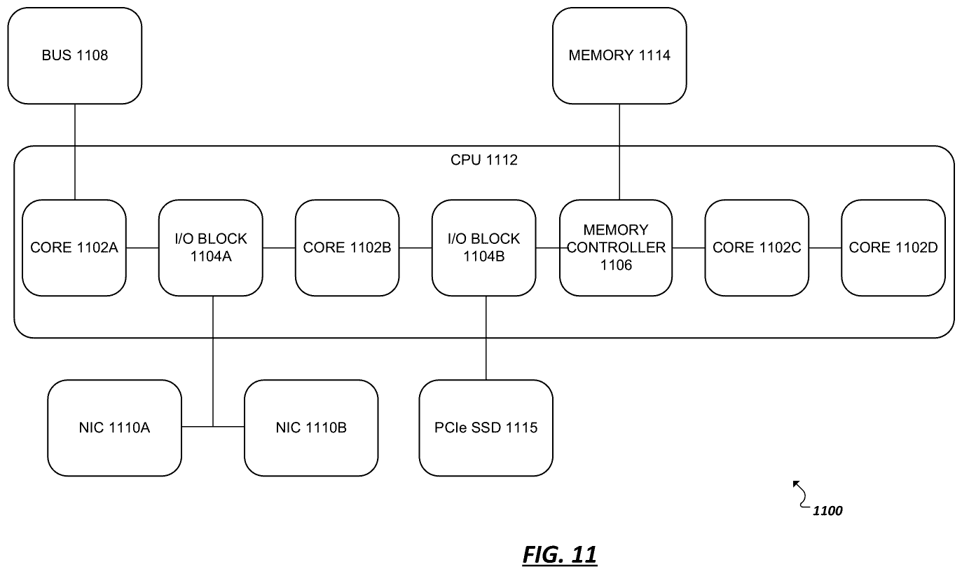

Note that the apparatus', methods', and systems described above may be implemented in any electronic device or system as aforementioned. As a specific illustration, FIG. 11 provides an exemplary implementation of a processing device such as one that may be included in a network processing device. It should be appreciated that other processor architectures may be provided to implement the functionality and processing of requests by an example network processing device, including the implementation of the example network processing device components and functionality discussed above. Further, while the examples discussed above focus on the use of CXL and CXL-based resource pooling, it should be appreciated that reference to CXL is as an illustrative example only. Indeed, the more generalized concepts disclosed herein may be equally and advantageously applied to other interconnects and interconnect protocols that facilitate similar resource pooling, among other examples.

Referring to FIG. 11, a block diagram 1100 is shown of an example data processor device (e.g., a central processing unit (CPU)) 1112 coupled to various other components of a platform in accordance with certain embodiments. Although CPU 1112 depicts a particular configuration, the cores and other components of CPU 1112 may be arranged in any suitable manner. CPU 1112 may comprise any processor or processing device, such as a microprocessor, an embedded processor, a digital signal processor (DSP), a network processor, an application processor, a co-processor, a system on a chip (SOC), or other device to execute code. CPU 1112, in the depicted embodiment, includes four processing elements (cores 1102 in the depicted embodiment), which may include asymmetric processing elements or symmetric processing elements. However, CPU 1112 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 1112, as illustrated in FIG. 11, includes four cores—cores 1102A, 1102B, 1102C, and 1102D, though a CPU may include any suitable number of cores. Here, cores 1102 may be considered symmetric cores. In another embodiment, cores may include one or more out-of-order processor cores or one or more in-order processor cores. However, cores 1102 may be individually selected from any type of core, such as a native core, a software managed core, a core adapted to execute a native Instruction Set Architecture (ISA), a core adapted to execute a translated ISA, a co-designed core, or other known core. In a heterogeneous core environment (e.g., asymmetric cores), some form of translation, such as binary translation, may be utilized to schedule or execute code on one or both cores.

A core 1102 may include a decode module coupled to a fetch unit to decode fetched elements. Fetch logic, in one embodiment, includes individual sequencers associated with thread slots of cores 1102. Usually a core 1102 is associated with a first ISA, which defines/specifies instructions executable on core 1102. Often machine code instructions that are part of the first ISA include a portion of the instruction (referred to as an opcode), which references/specifies an instruction or operation to be performed. The decode logic may include circuitry that recognizes these instructions from their opcodes and passes the decoded instructions on in the pipeline for processing as defined by the first ISA. For example, as decoders may, in one embodiment, include logic designed or adapted to recognize specific instructions, such as transactional instructions. As a result of the recognition by the decoders, the architecture of core 1102 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 1102, in one embodiment, recognize the same ISA (or a subset thereof). Alternatively, in a heterogeneous core environment, a decoder of one or more cores (e.g., core 1102B) may recognize a second ISA (either a subset of the first ISA or a distinct ISA).

In various embodiments, cores 1102 may also include one or more arithmetic logic units (ALUs), floating point units (FPUs), caches, instruction pipelines, interrupt handling hardware, registers, or other suitable hardware to facilitate the operations of the cores 1102.

Bus 1108 may represent any suitable interconnect coupled to CPU 1112. In one example, bus 1108 may couple CPU 1112 to another CPU of platform logic (e.g., via UPI). I/O blocks 1104 represents interfacing logic to couple I/O devices 1110 and 1115 to cores of CPU 1112. In various embodiments, an I/O block 1104 may include an I/O controller that is integrated onto the same package as cores 1102 or may simply include interfacing logic to couple to an I/O controller that is located off-chip. As one example, I/O blocks 1104 may include PCIe interfacing logic. Similarly, memory controller 1106 represents interfacing logic to couple memory 1114 to cores of CPU 1112. In various embodiments, memory controller 1106 is integrated onto the same package as cores 1102. In alternative embodiments, a memory controller could be located off chip.

As various examples, in the embodiment depicted, core 1102A may have a relatively high bandwidth and lower latency to devices coupled to bus 1108 (e.g., other CPUs 1112) and to NICs 1110, but a relatively low bandwidth and higher latency to memory 1114 or core 1102D. Core 1102B may have relatively high bandwidths and low latency to both NICs 1110 and PCIe solid state drive (SSD) 1115 and moderate bandwidths and latencies to devices coupled to bus 1108 and core 1102D. Core 1102C would have relatively high bandwidths and low latencies to memory 1114 and core 1102D. Finally, core 1102D would have a relatively high bandwidth and low latency to core 1102C, but relatively low bandwidths and high latencies to NICs 1110, core 1102A, and devices coupled to bus 1108.

“Logic” (e.g., as found in I/O controllers, power managers, latency managers, etc. and other references to logic in this application) may refer to hardware circuitry, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of a system on chip (SoC) and another hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the ‘capable of/to,’ ‘operable to phrase ‘to,’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

The following examples pertain to embodiments in accordance with this Specification. Example 1 is an apparatus including: a network processing device including: a cache; a first interface to couple to a network, where data is received at the first interface from user equipment in a radio access network and the data describes attributes of the radio access network; termination circuitry to decode the data to generate RAN data; a classification engine to: determine a priority level for the RAN data; determine a block of memory in a processor device for the RAN data based on the priority level; and generate a cache line in the cache to store the RAN data, where the cache line is associated with the block of memory; and a second interface to couple to the processor device, where the cache line is to be flushed to the block of memory with the RAN data based on the priority level.

Example 2 includes the subject matter of example 1, where the second interface is to implement a link based on a cache-coherent interconnect protocol and the cache line is flushed based on the cache-coherent interconnect protocol.

Example 3 includes the subject matter of any one of examples 1-2, where the interconnect protocol includes a plurality of sub-protocols.

Example 4 includes the subject matter of example 3, where the plurality of protocols includes an I/O subprotocol, a memory subprotocol, and a cache coherent sub-protocol.

Example 5 includes the subject matter of example 4, where the interconnect protocol includes a Compute Express Link (CXL)-based protocol.

Example 6 includes the subject matter of any one of examples 1-5, where RAN data is for use in performing connection management for the radio access network.

Example 7 includes the subject matter of example 6, where the connection management is based on an O-RAN architecture.

Example 8 includes the subject matter of example 7, where the data received from an E2 node over an E2 interface, and the termination circuitry includes E2 termination circuitry.

Example 9 includes the subject matter of any one of examples 1-8, where the priority level is determined based on a priority level definition associated with a RAN intelligent controller (RIC) to be executed at the processor device.

Example 10 includes the subject matter of any one of examples 1-9, further including a bound memory register to: identify a plurality of blocks of memory in the processor; and associate each of the plurality of blocks of memory to a respective one of a plurality of different priority levels, where the classification engine uses the bound memory register to determine that the block of memory corresponds to the priority level.

Example 11 includes the subject matter of any one of examples 1-10, where the RAN includes a 5G wireless network.

Example 12 is an apparatus including: a memory; a processor; a Compute Express Link (CXL)-based port to connect to a network processing device over a CXL-based link, where radio access network (RAN) data is evicted from cache of the network processing device to the memory over the CXL-based link; a RAN controller, executed by the processor to: access the RAN data from an address in the memory; use the RAN data to perform a task associated with connection management for user equipment in a particular RAN; generate connection management result data based on performance of the task; and send the connection management result data to the network processing device for delivery to a radio access network associated with the RAN data.

Example 13 includes the subject matter of example 12, where the RAN controller is to define priority levels for RAN data passed to the memory from the network processing device, where the RAN data is evicted based on one of the priority levels identified for the RAN data by the network processing device.

Example 14 includes the subject matter of example 13, where the RAN controller is further to write to a control register of the network processing device to define a mapping of memory blocks in the memory to the priority levels.

Example 15 includes the subject matter of any one of examples 12-14, where the RAN controller run a set of one or more xApps, where the one or more xApps are to consume the RAN data to generate an output for use in the connection management.

Example 16 includes the subject matter of any one of examples 12-15, where the RAN controller includes an O-RAN near-real-time (RT) RAN intelligent controller (RIC).

Example 17 includes the subject matter of any one of examples 12-16, where the RAN data is evicted from the cache through a writeback associated with a read request from the network processing device based on a CXL-based protocol.

Example 18 includes the subject matter of any one of examples 12-17, where the RAN includes a 5G wireless network.

Example 19 is a method including: receiving data from a radio access network (RAN) entity, where the data describes attributes of a RAN; parsing the data to determine that a particular one of a plurality of priority levels is to apply to the data; determining a particular range of memory of a host processor associated with the particular priority level; generating a cache line at a network processing device to correspond to the range of memory block, where the cache line includes the data; and evicting the cache line to the particular range of memory using Compute Express Link (CXL)-based semantics.

Example 20 includes the subject matter of example 19, where E2 termination associated with receipt of the data from the RAN entity is performed at the network processing device rather than the host processor, where the RAN entity includes an E2 node.

Example 21 includes the subject matter of any one of examples 19-20, where cache lines associated with higher levels of priority are to be evicted before cache lines associated with lower levels of priority.

Example 22 includes the subject matter of any one of examples 19-20, further including: receiving result data from the host processor device based on the data; and sending the result data to the RAN entity for use in connection management within the RAN.

Example 23 includes the subject matter of any one of examples 19-22, where RAN data is for use in performing connection management for the radio access network.

Example 24 includes the subject matter of example 23, where the connection management is based on an O-RAN architecture.

Example 25 includes the subject matter of example 24, where the data received from an E2 node over an E2 interface, and the termination circuitry includes E2 termination circuitry.

Example 26 includes the subject matter of any one of examples 19-25, where the priority level is determined based on a priority level definition associated with a RAN intelligent controller (RIC) to be executed at the processor device.

Example 27 includes the subject matter of any one of examples 19-26, further including a bound memory register to: identify a plurality of blocks of memory in the processor; and associate each of the plurality of blocks of memory to a respective one of a plurality of different priority levels, where the classification engine uses the bound memory register to determine that the block of memory corresponds to the priority level.

Example 28 includes the subject matter of any one of examples 19-27, where the RAN includes a 5G wireless network.

Example 29 is a system including means to perform the method of any one of examples 19-28.

Example 30 is a non-transitory machine readable storage medium with instructions stored thereon, the instructions executable to cause a machine to: receive radio access network (RAN) data flushed from cache of a network processing device to memory of a host processor over a cache-coherent link; use the RAN data to perform a task associated with connection management for user equipment in a particular RAN; generate connection management result data based on performance of the task; and send the connection management result data to the network processing device over the link for delivery to a radio access network associated with the RAN data.

Example 31 includes the subject matter of example 30, where the instructions are further executable to cause the machine to configure a bound memory table of the network processing device to associate the cache with a particular block of memory in the memory of the host processor.

Example 32 includes the subject matter of example 31, where the particular block of memory is associated with one of a plurality of priority levels to be assigned to RAN data by the network processing device.

Example 33 includes the subject matter of example 32, where the instructions are further executable to cause the machine to define assignment of the plurality of priority levels by the network processing device.

Example 34 is a system including: a host processor device including a processor and a memory; and a network processing device including: a cache; a first interface to couple to a network, where radio access network (RAN) data is received at the first interface from user equipment in a radio access network and the data describes attributes of the radio access network; a classification engine to: determine a priority level for the RAN data; determine a block of the memory of the host processor device for the RAN data based on the priority level; and generate a cache line in the cache to store the RAN data, where the cache line is associated with the block of memory; and a second interface to couple to the host processor device, where the cache line is to be flushed to the block of memory with the RAN data based on the priority level.

Example 35 includes the subject matter of example 34, where an interface termination for RAN data is provided at the network processing device instead of the host processor device.

Example 36 includes the subject matter of example 35, further including an E2 node, where the network processing device receives the RAN data from the E2 node and is to decode the RAN data with E2 termination circuitry.

Example 37 includes the subject matter of any one of examples 34-36, where the host processor device further includes a RAN intelligent controller (RIC) to perform connection management for the radio access network based on the RAN data.

Example 38 includes the subject matter of example 37, where the RIC is based on an O-RAN architecture.

Example 39 includes the subject matter of example 38, where the RIC is to execute one or more xApps to perform connection management tasks based on the RAN data.

Example 40 includes the subject matter of any one of examples 37-39, where the priority level is one of a plurality of priority levels defined based on the RIC.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a network processing device comprising:
a cache;
a first interface to couple to a network, wherein data is received at the first interface from user equipment in a radio access network and the data describes attributes of the radio access network;
termination circuitry to decode the data to generate RAN data;
a classification engine to:
determine a priority level for the RAN data;
determine a block of memory in a processor device for the RAN data based on the priority level; and
generate a cache line in the cache to store the RAN data, wherein the cache line is associated with the block of memory; and
a second interface to couple to the processor device, wherein the cache line is to be flushed to the block of memory with the RAN data based on the priority level.

2. The apparatus of claim 1, wherein the second interface is to implement a link based on a cache-coherent interconnect protocol and the cache line is flushed based on the cache-coherent interconnect protocol.

3. The apparatus of claim 1, wherein the interconnect protocol comprises a plurality of sub-protocols.

4. The apparatus of claim 3, wherein the plurality of protocols comprises an I/O subprotocol, a memory subprotocol, and a cache coherent sub-protocol.

5. The apparatus of claim 4, wherein the interconnect protocol comprises a Compute Express Link (CXL)-based protocol.

6. The apparatus of claim 1, wherein RAN data is for use in performing connection management for the radio access network.

7. The apparatus of claim 6, wherein the connection management is based on an O-RAN architecture.

8. The apparatus of claim 7, wherein the data received from an E2 node over an E2 interface, and the termination circuitry comprises E2 termination circuitry.

9. The apparatus of claim 1, wherein the priority level is determined based on a priority level definition associated with a RAN intelligent controller (RIC) to be executed at the processor device.

10. The apparatus of claim 1, further comprising a bound memory register to:
identify a plurality of blocks of memory in the processor;
associate blocks of memory in the plurality of blocks of memory to respective ones of a plurality of different priority levels, wherein the classification engine uses the bound memory register to determine that the block of memory corresponds to the priority level.

11. An apparatus comprising:
a memory;
a processor;
a Compute Express Link (CXL)-based port to connect to a network processing device over a CXL-based link, wherein radio access network (RAN) data is evicted from cache of the network processing device to the memory over the CXL-based link;
a RAN controller, executed by the processor to:
access the RAN data from an address in the memory;
use the RAN data to perform a task associated with connection management for user equipment in a particular RAN;
generate connection management result data based on performance of the task; and
send the connection management result data to the network processing device for delivery to a radio access network associated with the RAN data.

12. The apparatus of claim 11, wherein the RAN controller is to define priority levels for RAN data passed to the memory from the network processing device, wherein the RAN data is evicted based on one of the priority levels identified for the RAN data by the network processing device.

13. The apparatus of claim 12, wherein the RAN controller is further to write to a control register of the network processing device to define a mapping of memory blocks in the memory to the priority levels.

14. The apparatus of claim 11, wherein the RAN controller run a set of one or more xApps, wherein the one or more xApps are to consume the RAN data to generate an output for use in the connection management.

15. The apparatus of claim 11, wherein the RAN controller comprises an O-RAN near-real-time (RT) RAN intelligent controller (RIC).

16. The apparatus of claim 11, wherein the RAN data is evicted from the cache through a writeback associated with a read request from the network processing device based on a CXL-based protocol.

17. A method comprising:
receiving data from a radio access network (RAN) entity, wherein the data describes attributes of a RAN;
parsing the data to determine that a particular one of a plurality of priority levels is to apply to the data;
determining a particular range of memory of a host processor associated with the particular priority level;
generating a cache line at a network processing device to correspond to the range of memory block, wherein the cache line comprises the data; and
evicting the cache line to the particular range of memory using Compute Express Link (CXL)-based semantics.

18. The method of claim 17, wherein E2 termination associated with receipt of the data from the RAN entity is performed at the network processing device rather than the host processor, wherein the RAN entity comprises an E2 node.

19. The method of claim 17, wherein cache lines associated with higher levels of priority are to be evicted before cache lines associated with lower levels of priority.

20. The method of claim 17, further comprising:
receiving result data from the host processor device based on the data; and
sending the result data to the RAN entity for use in connection management within the RAN.
